(19) United States
(12) Patent Application Publication
(10) Pub. No.: US 2002/0094868 A1
(43) Pub. Date: Jul. 18, 2002

(54) Methods for interactive internet advertising, apparatuses and systems including same

(76) Inventors: Alma Tuck, Provo, UT (US); Jeff Roberts, Provo, UT (US); Daniel W. Harman, Orem, UT (US); Andrew K. Smith, Lehi, UT (US); Mark W. Preston, Lehi, UT (US); Fred W. Chaney, Provo, UT (US)

Correspondence Address: Paul C. Oestreich, TRASK BRITT, P.O. BOX 2550, Salt Lake City, UT, 84110, US

(21) Appl. No.: 09/761,481

(22) Filed: Jan. 16, 2001

(51) Int. Cl. A63F 9/24; A63F 13/00; G06F 17/00; G06F 19/00

(52) U.S. Cl. 463/42; 463/1

(57) ABSTRACT

The present invention comprises an apparatus, system and method for delivering rich-media advertising for the Internet including viewer tracking, online sales interface and integration with the advertiser/retailer. The rich-media advertising of the invention includes full stereo audio, video and animation capabilities. The viewer tracking of the invention includes demographics of the viewer, geographic location, timing and viewer habits. The online sales interface of the invention includes options to buy online, options to leave the host website, options to print promotional offers, mapping tools and options to view other advertiser's promotional offers with search capability.

### BACKGROUND OF THE INVENTION

1. Field of the Invention

The present invention relates generally to Internet advertising. More particularly, the present invention includes methods, devices and systems for interactive Internet advertising.

2. Description of the Related Art

The origins of the Internet can be traced as far back as 1962 when J. C. R. Licklider proposed a “galactic network” that would allow people to interact via computer. The Internet in its current form has become a pervasive medium for communicating, obtaining information, and conducting business. Tim Berners-Lee at the European Centre for Nuclear Research (CERN) has been credited as being the first to envision the World Wide Web (also referred to as “the Web”) with hypertext linking. The World Wide Web concept and browsers with a graphical user interface (GUI) have transformed the Internet into a global information database. The first commercial Web browser with a point-and-click GUI was the Mosaic browser produced in 1993 by Marc Andreessen at the National Center for Supercomputer Research (NCSA). Since the early days of Mosaic, browsers have become commonplace on desktop computers, laptop computers, personal digital assistants (PDAs) and even cellular telephones.

A typical browser displays computer files formatted according to hypertext markup language protocol (HTML). An individual file is addressed by a hypertext transfer protocol (HTTP) command. HTML files may include references to other HTML files and references to image files, e.g., bit-map (.bmp) files, graphic interchange format (.GIF) files, joint pictures expert group (.JPG) files and tagged image file format (.tiff) files. Other media formats are also supported by modern browsers including, for example, audio files in .wav or .MP3 formats and video files in .mpeg, .mov, and .avi formats. Accessing multi-media files may require a “plug-in” software application be associated with the browser.

Conducting business electronically on the Internet through a website, or “E-commerce”, is a rapidly growing aspect of traditional brick and mortar retailers and Internet start-up companies alike. Money spent on Internet advertising grows every year and is likely to continue to grow along with the growth of E-commerce.

Revenue may be generated by operators of websites through sales of goods and services and also by selling advertising. Revenue generated from selling advertising space on popular Web sites is so significant that, for some websites, it is the primary source of revenue. Internet portals, and search engines are among the most widely viewed websites. The popularity of a website is typically measured by “hits” or viewers viewing the site. websites with high hit rates can charge higher advertising fees than websites with lower hit rates.

Internet advertising comes in many forms. Traditional forms of Internet advertising are not unlike conventional advertising with graphical images except that the graphical images may be hosted on Web pages on an advertiser's website. With such Web page advertising, the retailer has the opportunity to capture the attention of the viewer, and if successful, a sale will be made. However, this form of Internet advertising requires the viewer to address the advertiser's website.

Another form of Internet advertising relies on bringing the viewer to an advertiser's website. For example, when an Internet user accesses a search engine website, e.g., altavista.com or yahoo.com, it is not uncommon to see “banner” advertisements (banner ads) that form a portion of the viewer's screen and typically include static graphics. Banner ads sometimes include simulated motion, or animated graphics to get the attention of the viewer. When the viewer clicks on any portion of the banner advertisement, the viewer is typically hyperlinked to the advertiser's website. Once the viewer has been transported to the advertiser's website, the advertiser has the opportunity to make a sale if the viewer is interested in the advertiser's goods and services.

Banner ads are so pervasive that many Internet users have grown accustomed to them and can mentally filter them out without bothering to click on the ad and be transported to the advertiser's website. This is an undesirable result for the advertiser. The “click-through” rate on banner advertisements is believed to be extremely low. On the order of one or two percent of all banner ads presented to a viewer actually result in the viewer clicking on the advertisement to see the advertiser's website. Furthermore, only a percentage of such “click-throughs” result in a sale.

Another problem with banner ads is the fact that they are largely untargeted. That is to say, the banner advertisement is available to all viewers whether they have significant or minimal interest in the goods and services being advertised. Advertisers will pay a premium to send their advertising to potential customers who show an interest for the kinds of goods and services being retailed by the advertiser.

Yet another form of Internet advertising includes pop-up windows that appear on the viewer's browser automatically, either when the viewer first accesses a website or when leaving the website for a new address (another website). Pop-up window advertisements may have graphics and links just like any other HTML formatted page. Pop-up window advertisements tend to be more noticeable by viewers because the pop-up window covers at least a portion of the viewable screen space. However, such pop-up windows are also very intrusive to the viewer's surfing experience for exactly the same reason, and as a result, are frequently summarily closed without any click-through. Pop-up window advertisements also suffer from being untargeted.

More recently, advertisers have attempted to improve the attractiveness of Internet advertising by including the use of sound, animated or rotating logos and pictures, scrolling information. For example, Hot Java™, from Sun Microsystems, provides a specialized programming language for developing and executing small software application programs that provide multi-media content. However, the multi-media effects made available through Hot Java™ are only available while the user is viewing a Web page incorporating the Hot Java™ technology.

In addition to being untargeted, passive or obtrusive, other known problems associated with conventional Internet advertising include: a lack of information gathered about viewers of Internet advertising, limited bandwidth for transmitting large graphics or video files from the advertiser's server to the user's computer, access to advertiser's advertisements is initiated by the user rather than the advertiser, hyperlinking to the advertiser's website and away from the Web page which contained the banner ad or link and inability to customize the advertisement to a local brick and mortar retailer if desired. Thus, there exists a need in the art for interactive Internet advertising and devices and systems for addressing the shortcomings of conventional Internet advertising.

### SUMMARY OF THE INVENTION

The present invention comprises an apparatus, system and method for delivering rich-media advertising for the Internet including viewer tracking, online sales interface and integration with the advertiser/retailer. The rich-media advertising of the invention includes full stereo audio, video and animation capabilities. The viewer tracking of the invention includes demographics of the viewer, geographic location, timing and viewer habits. The online sales interface of the invention includes options to buy online, options to leave the host website, options to print promotional offers, mapping tools and options to view other advertiser's promotional offers with search capability.

In a system embodiment of the present invention for delivering rich-media Internet advertisement wherein the advertisement may optionally include audio, video and animation capabilities, the system may include a viewer computer configured for Internet connection, a server computer configured for Internet connection, and a computer program configured for being electronically transmitted through the Internet from a server computer to a viewer computer when a viewer addresses the server computer. The computer program of the system is configured to pre-load in background on the viewer computer, execute the rich-media Internet advertisement in a window on the viewer computer for between about 2 to 30 seconds after said pre-loading, and leave a promotional window to gather a mouse-over or a click-through from the viewer.

In a method embodiment according to the present invention, for delivering rich-media Internet advertising wherein the advertisement may optionally include stereo audio, video and animation capabilities, the method includes providing a host computer configured for hosting a web site including Internet connection. The method includes providing a server computer configured for Internet connection and including an advertising computer program stored in memory in the server computer. The method also includes providing a viewer computer configured for Internet connection and including an Internet browser. The method includes profiling a viewer addressing the web site on the host computer through the Internet and transmitting the advertising computer program from the server computer to the viewer computer. The method includes pre-loading the transmitted advertising computer program in background on the viewer computer, executing a first portion of the advertising computer program in an advertising window on the viewer computer for between about 2 seconds to about 30 seconds and automatically closing the advertising window. The method includes executing a second portion of the advertising computer program in a promotion window to confirm viewer's attention and automatically closing the promotion window if the viewer's attention remains unconfirmed for between about 2 seconds to about 60 seconds after the promotion window opens.

In a method for configuring an Internet advertising campaign for advertising goods or services over the Internet in accordance with the present invention, the method includes designing the Internet advertising campaign, selecting features for the Internet advertising campaign and forming a contract between the merchant and the Internet advertising agency for development of the Internet advertising campaign. The method also includes securing advance payment from the merchant to the Internet advertising agency for the development of the Internet advertising campaign, and developing the Internet advertising campaign in accordance with the Internet advertising design, the selected features for the Internet advertising campaign and the contract.

These embodiments, methods and attendant advantages of the present invention will be readily understood by reading the following detailed description in conjunction with the accompanying figures of the drawings.

### BRIEF DESCRIPTION OF THE DRAWINGS

In the drawings, which illustrate what is currently regarded as the best mode for carrying out the invention and in which like reference numerals refer to like parts in different views or embodiments:

FIGS. 1A and 1B are a flow chart of a method of delivering rich-media Internet advertising of the present invention.

FIG. 2 is a block diagram of a system for sending, receiving and executing rich-media Internet advertising in accordance with the present invention.

FIG. 3A is a flow chart of a method of configuring an Internet advertising campaign for advertising goods or services over the Internet in accordance with the present invention.

FIGS. 3B-3D are flow charts providing added detail to the method of configuring an Internet advertising campaign of FIG. 3A.

FIG. 4 is a block diagram of a system for developing, delivering, and monitoring an Internet advertising campaign in accordance with the present invention.

FIG. 5 is a picture of an exemplary rich-media advertisement in accordance with the method of FIGS. 1A and 1B of the present invention.

FIG. 6 is a picture of an exemplary promotion window displaying a trailer in accordance with the method of FIGS. 1A and 1B of the present invention.

FIG. 7 is a picture of an exemplary sales portal window in accordance with the method of FIGS. 1A and 1B of the present invention.

### DETAILED DESCRIPTION OF THE INVENTION

The present invention comprises methods for interactive Internet advertising, devices and systems including same. The terms “server computer” and “advertising server computer” may be used interchangeably herein.

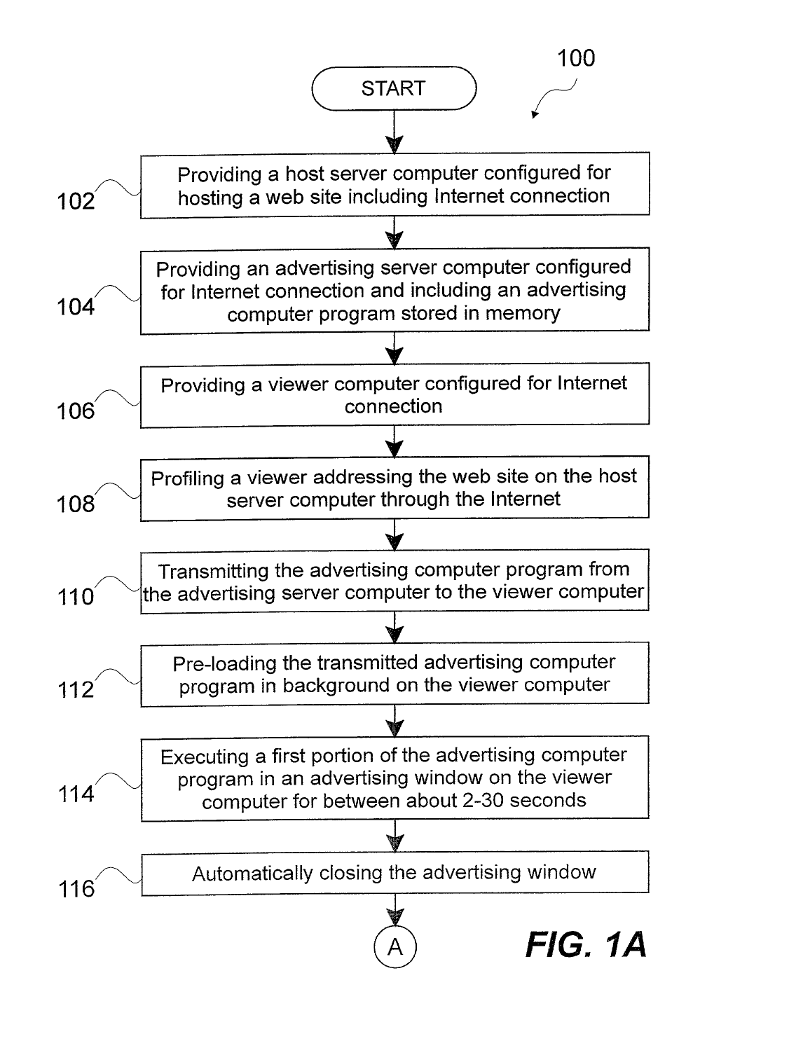

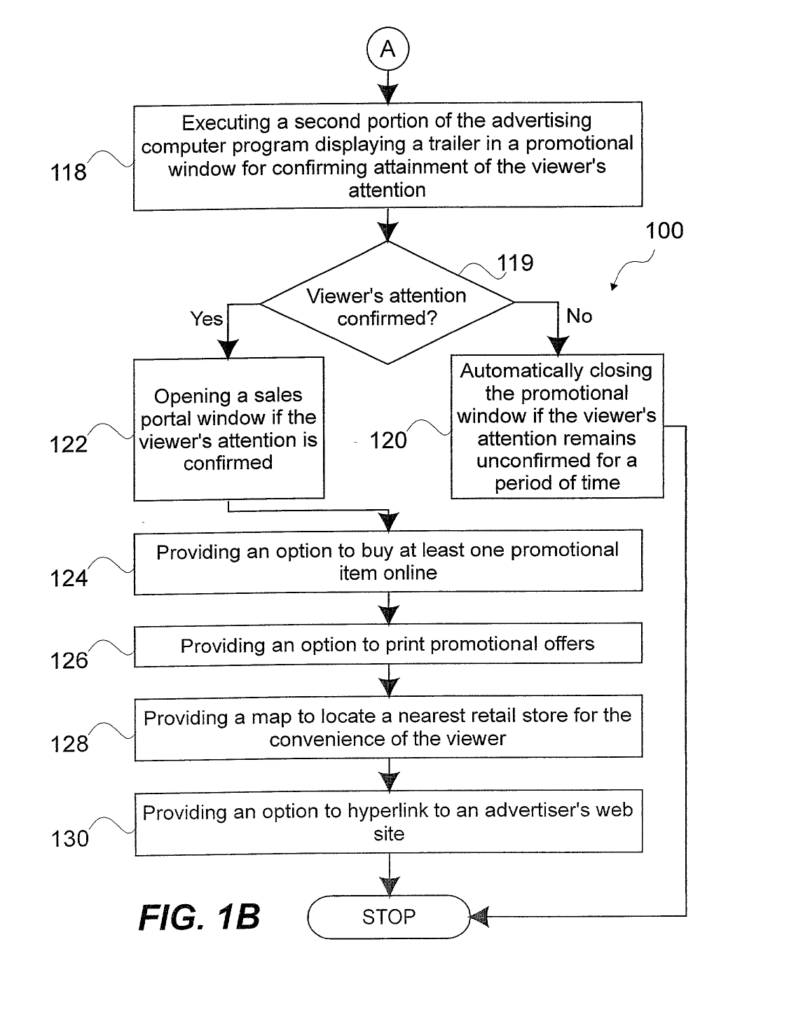

FIGS. 1A and 1B are a flow chart of a method 100 of delivering rich-media Internet advertising of the present invention. Method 100, as shown in the flow charts of FIGS. 1A and 1B, includes providing 102 a host computer configured for hosting a web site and configured for Internet connection, providing 104 a server computer configured for Internet connection and including an advertising computer program stored in the server, providing 106 a viewer computer configured for Internet connection, profiling 108 a viewer addressing the web site on the host computer through the Internet, transmitting 110 the advertising computer program from the server computer to the viewer computer, pre-loading 112 the transmitted advertising computer program in background on the viewer computer, executing 114 a first portion of the transmitted advertising computer program in an advertising window on the viewer computer for between about 2-30 seconds and automatically closing 116 the advertising window.

Method 100 further includes executing 118 a second portion of the advertising computer program in a promotional window displaying a trailer for confirming attainment of the viewer's attention, determining 119 whether a viewer's attention has been confirmed, automatically closing 120 the promotional window if the viewer's attention remains unconfirmed for a period of time after the promotional window opens, opening 122 a sales portal window if the viewer's attention is confirmed, providing 124 an option to buy at least one promotional item online, providing 126 an option to print promotional offers, providing 128 a map to locate a nearest retail store for the convenience of the viewer, and providing 130 an option to hyperlink to an advertiser's web site.

Profiling a viewer 108 who has addressed the web site on the host computer may include the host computer returning to the viewer computer a number identifying the merchant who is advertising on the host computer or “merchant number”. Profiling 108 a viewer may also include the host computer returning to the viewer computer a number identifying set of advertisements that the merchant has preselected to advertise when the web site is addressed, referred to as a “wheel number”. The merchant number and wheel number may be collectively be referred to as “merchant specific information.” One of skill in the art will recognize that other information may be included as necessary in the “merchant specific information.”

Profiling 108 a viewer may also include the viewer computer sending the merchant specific information along with a session identification number, or “session ID” to the server computer. Profiling 108 a viewer may also include the server computer transparently communicating with the host computer to allow the server computer to send a rich-media Internet advertisement to the viewer computer based on the merchant specific information and/or the session ID. The profiling 108 of a viewer is performed automatically and without any indication to the viewer, i.e., the viewer is not aware that he or she has been profiled. Profiling 108 a viewer may also include leaving a “cookie” on the viewer computer to track demographic information about the viewer for future use. Profiling 108 a viewer may be performed by inserting a merchant number and merchant wheel on the last line of the hyper-text markup language (HTML) code of a web page on the host web site. Other means of tracking the viewer as known to one of ordinary skill in the art may also be used consistent with the present invention.

Profiling 108 a viewer may include gathering such information from the viewer as time information, demographics, geographic location, hardware information and tracking information. Time information may include, for example and not by way of limitation, the amount of time the viewer spends online (duration) and current time on the viewer's computer. Geographic location may include, for example and not by way of limitation, address, zip code, city, county, state, country and viewer's Internet Service Provider (ISP). Information about the viewer's ISP may indirectly provide a rough geographical location of the viewer. Demographics may include, for example and not by way of limitation, sex, age, average income, education level, hobbies and interests (auto, health, fitness, sports, business, apparel, etc.) of the viewer. Hardware information may include, for example and not by way of limitation, Internet connection speed and processor speed, available disk space, available memory space. Tracking information may include, for example and not by way of limitation, the viewer's viewing habits, the web page (address) from which the viewer was previously viewing (where the viewer came from before viewing the advertising web page), the web page (address) to which the viewer went after viewing the advertising web page, the click-through rate of the viewer, the history of the viewer's click-through rate, programs stored on the viewer computer, e.g., application programs, browser programs, plug-in programs, versions of such computer programs and cookies.

Transmitting 110 the advertising computer program from the advertising server computer to the viewer computer may be based, at least in part, by the merchant specific information that is first transferred from the host computer to the viewer computer and then to the advertising computer during the profiling 108 of a viewer. The advertising computer program selected for transmission to the viewer computer may be preselected based on the merchant specific information. Alternatively, the advertising computer program selected for transmission to the viewer computer may be randomly selected from among a plurality of advertising computer programs based on the merchant specific information and/or the session ID.

Pre-loading 112 the transmitted advertising computer program in background on the viewer computer is performed automatically and transparently, i.e., the viewer is not made aware that the advertising computer program is being pre-loaded. The advertising computer program is completely loaded before execution (pre-loaded) rather than beginning execution during loading. The reason for pre-loading the advertising computer program is to ensure optimum delivery of the Internet advertising including full stereo audio, full motion video graphics and animation. Pre-loading of the advertising computer program is preferred so that the execution of the program is not degraded by video or audio information not being timely available and causing gaps or delays during execution. To the extent that the bandwidth of the Internet connection is sufficiently high, pre-loading may not be necessary for the advertising computer program of the present invention. However, pre-loading is presently the preferred method of delivery prior to execution of the program. While the advertising computer program of the present invention may be a self-contained and self-executing computer program, the presently preferred embodiment of the advertising computer program of the present invention runs with a plug-in for conventional Internet browsers, for example, and not by way of limitation, Macromedia Flash™, available from Macromedia, Inc., San Francisco, Calif.

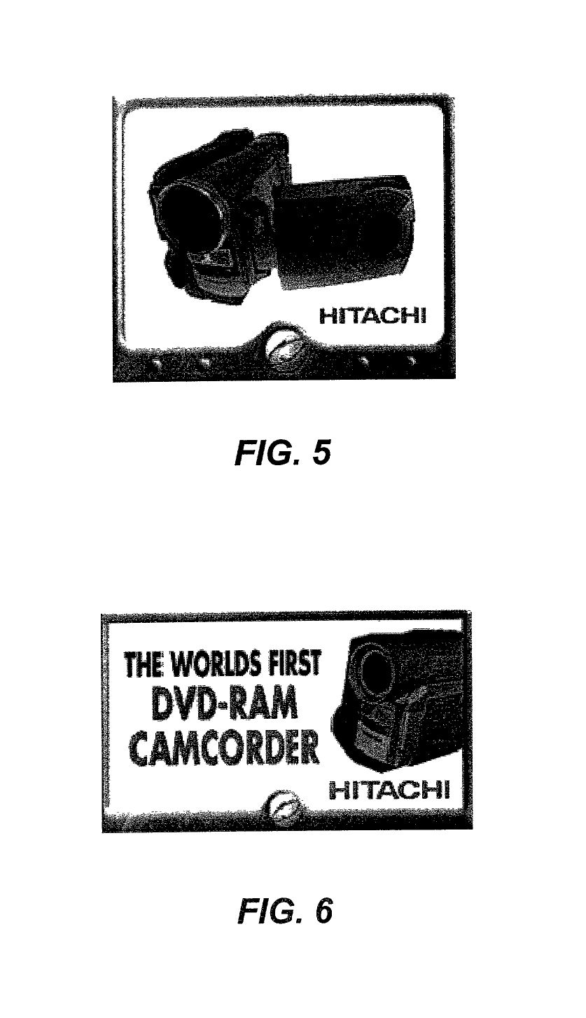

Executing 114 a first portion of the advertising computer program to display a rich-media advertisement in an advertising window on the viewer computer for between about 2-30 seconds is performed preferably after pre-loading as noted above. The first portion of the advertising computer program executes a rich-media Internet advertisement, optionally including full stereo audio, full motion video and graphic animation, automatically after pre-loading. An exemplary picture of a rich-media Internet advertisement is shown in FIG. 5.

While the first portion of the advertising computer program may execute for between about 2-30 seconds, it is preferable for the first portion of the advertising computer program to executes in an advertising window for a duration of between about 5 seconds to about 10 seconds. Upon completion of execution of the first portion of the advertising computer program, the advertising window in which the advertisement is visually displayed automatically closes 116. The advertising window in which the first portion of the advertising computer program is visually displayed may or may not have a frame with controls to close it.

The purpose of the first portion of the advertising computer program is to get the attention of the viewer in a manner that overcomes problems associated with conventional banner advertisements and untargeted pop-up window advertisements. The first portion of the advertising computer program of the present invention is not passive like banner advertisements because it includes full stereo audio, full motion video and graphic animation. Additionally, unlike conventional pop-up advertisements, the advertising computer program of the present invention automatically closes without user intervention, and is thus, less obtrusive than conventional pop-up advertisements.

Executing 118 a second portion of the advertising computer program in a promotional window displaying a trailer for confirming attainment of the viewer's attention includes visually displaying an unobtrusive graphical display (the trailer) in a promotional window. FIG. 6 is a picture of an exemplary trailer in a promotional window.

Confirmation of the viewer's attention may come in the form of a “mouse-over” event or a “click-through” event. A mouse-over event is when the viewer moves a cursor on a display device (typically a monitor or computer screen) over the region defined by the promotional window. A click-through event includes a mouse-over event in combination with a “click” of a button on a pointing device used by the viewer. One of skill in the art will recognize that a “click” may be a tap on a touch pad or a press of a button on a mouse key, track ball or other pointing device.

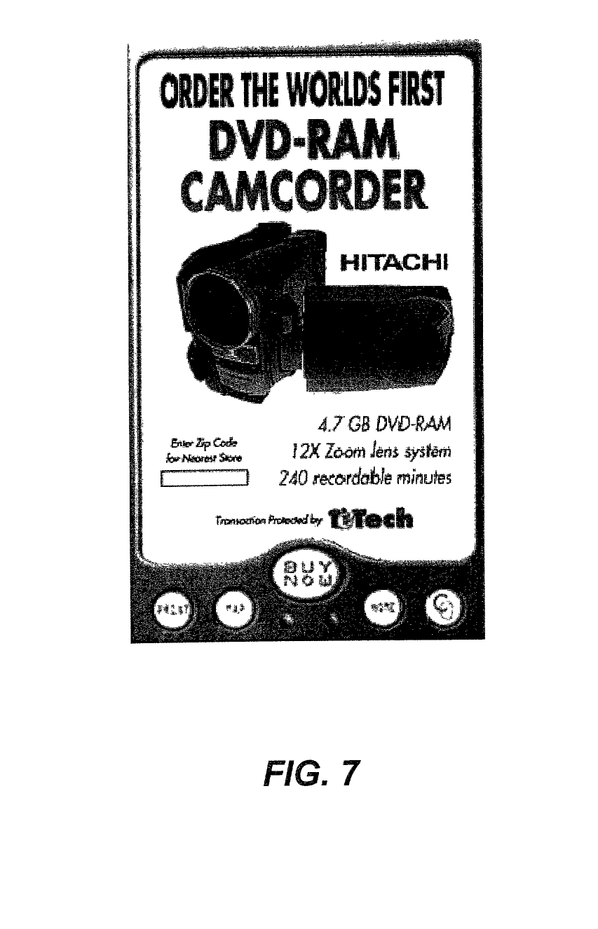

Decision point 119 allows the advertising computer program to continue executing or close depending on whether the viewer is sufficiently interested in seeing more information about the product or service being promoted in the first portion of the advertising computer program. If the viewer's attention is confirmed, a sales portal window is opened 122. FIG. 7 is a picture of an exemplary sales portal window.

If the viewer's attention remains unconfirmed for a period of time, the advertising computer program automatically closes 120 the promotional window with no further action taking place. While the promotional window may be left on the viewer's computer screen for a period of time defined as a duration from between about 2 seconds to about 60 seconds, it is preferable for the advertising computer program to close automatically if the viewer's attention remains unconfirmed for a duration from between about 5 seconds to about 20 seconds. Thus, the promotional window is transient and disappears if the goal of obtaining the viewer's attention is unobtained for selected period of time. The automatic closing 120 of the promotional window also distinguishes the interactive Internet advertising of the present invention versus the obtrusive pop-up window of the prior art which requires user intervention whether or not the viewer is interested in the goods or services being promoted.

Providing 124 an option to buy at least one promotional item online may include, for example and not by way of limitation, a list of goods to select from, a drop down menu with indexed categories of goods, pricing information, availability, and the like. It should be noted that the at least one promotional item may be a service rather than a good. Furthermore, the goods and services pertaining to the at least one promotional item may be searchable by a search engine. Once the sales portal window has been opened 124, it remains open until the viewer closes it. Thus, the sales portal window is not transient and will not automatically close if left unattended as is characteristic of the promotional window.

Providing 126 an option to print a promotional offer in accordance with the present invention includes the capability to print a coupon for a discount on a promotional item. Providing 126 an option to print a promotional offer also includes the capability to print a coupon having a bar code imprinted on the coupon. Providing 126 an option to print a promotional offer may also include the capability of printing a coupon redeemable at a specific retail store or group of retail stores.

Providing 128 a map to locate a nearest retail store for the convenience of the viewer may include the capability to print the map for added convenience. The map may be based on the viewer's address (zip code or other identifying geographical information gathered during the profiling 108 described above) to the nearest retail outlet associated with the goods offered in the promotion. The map may further include directions to more than one retail store offering the promotional item in concert with the option to print 126 a promotional offer as described above.

Providing 130 an option to hyperlink to an advertiser's web site allows the viewer to actually point (or physically address) the viewer's browser to the advertiser's web site in case there is more information or something otherwise of interest to the viewer. An important feature of the method 100 of the present invention is that the viewer is not automatically hyperlinked away from the host server computer 102 web site. This feature allows a host server computer of the present invention to maintain a high user hit rate or connection time with a given viewer. Owners of host computers with particularly popular web sites or portals may be more inclined to allow advertising in accordance with the present invention because they are less likely to lose a viewer who would otherwise be automatically hyperlinked away to an advertiser's web site under the regime of conventional banner and pop-up advertising.

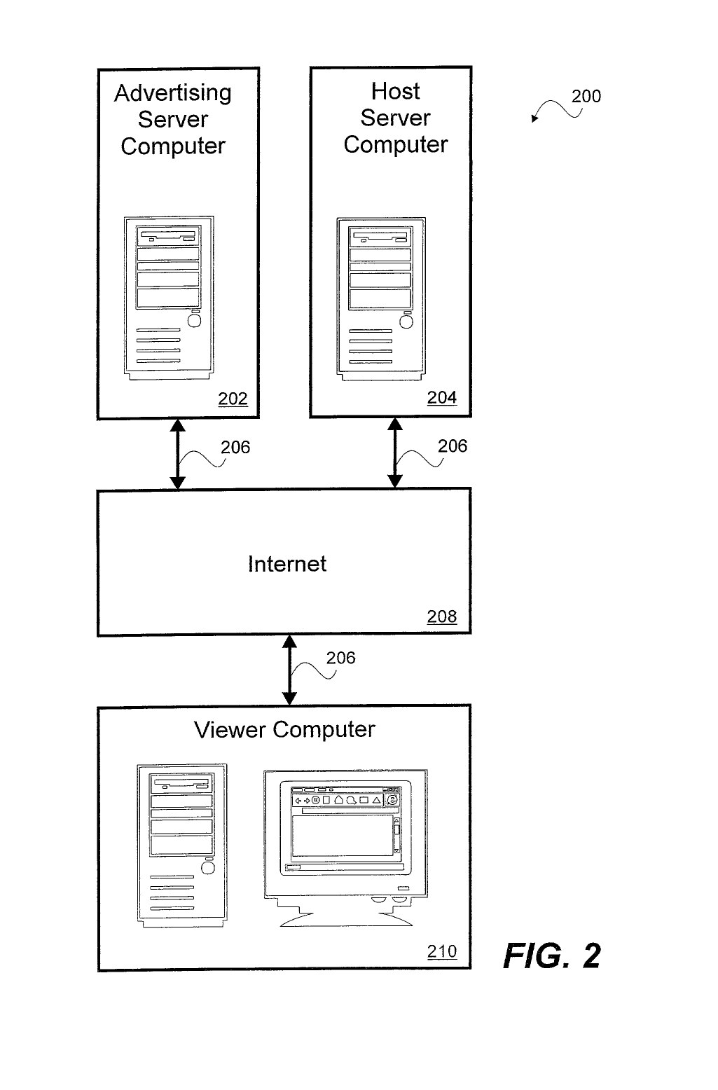

FIG. 2 is a block diagram of a system 200 for sending, receiving and executing rich-media Internet advertising in accordance with the present invention. System 200 may include an advertising server computer 202 configured for connection to the Internet 208 via an Internet connection 206. System 200 may also include a host server computer 204 configured for hosting a web site and configured for connection to the Internet 208 through an Internet connection 206. System 200 may also include a viewer computer 210 configured for connection to the Internet 208 via an Internet connection 206.

Internet connection 206 may be a dial-up modem and telephone line to an Internet Service Provider (ISP), not shown for clarity. Internet connection 206 may also be broadband Internet connection such as a network interface connection to a network with a digital subscriber line (DSL) connection, a cable modem connected to cable television lines or other broadband Internet connection. Internet connection 206 may also be an Internet capable portable telephone or personal digital assistant connecting to the Internet 208 through analog or digital cellular telephone networks.

Advertising server computer 202 may be any kind of computer hardware configured for Internet connection, preferably broadband Internet connection. One of skill in the art will recognize that the choice of computer hardware for advertising server computer 202 is within the knowledge of one of ordinary skill in the art and, thus, will not be further detailed herein. Host server computer 204 may be comprised of any kind of computer hardware suitable for hosting a web site and also configured preferably for broadband Internet connection. Similarly, viewer computer 210 may be any kind of personal computer or workstation, standalone or networked, including capability for connecting to the Internet, including a browser to navigate the Internet and view a web page on the advertising server computer 202.

Host server computer 204 may be owned or operated by an advertiser associated with a rich-media advertisement in accordance with the present invention. Alternatively, host server computer 204 may be owned or operated by an Internet portal or other third party that has sold advertising space, or the right to advertise, on its web site to an advertiser associated with a rich-media advertisement in accordance with the present invention. Host server computer 204 includes a web site that may be addressable by a viewer typing in an Internet Protocol (IP) address, a universal resource locator (URL), or simply linking to the address of the web site by a hyperlink on some other HTML sensitive document.

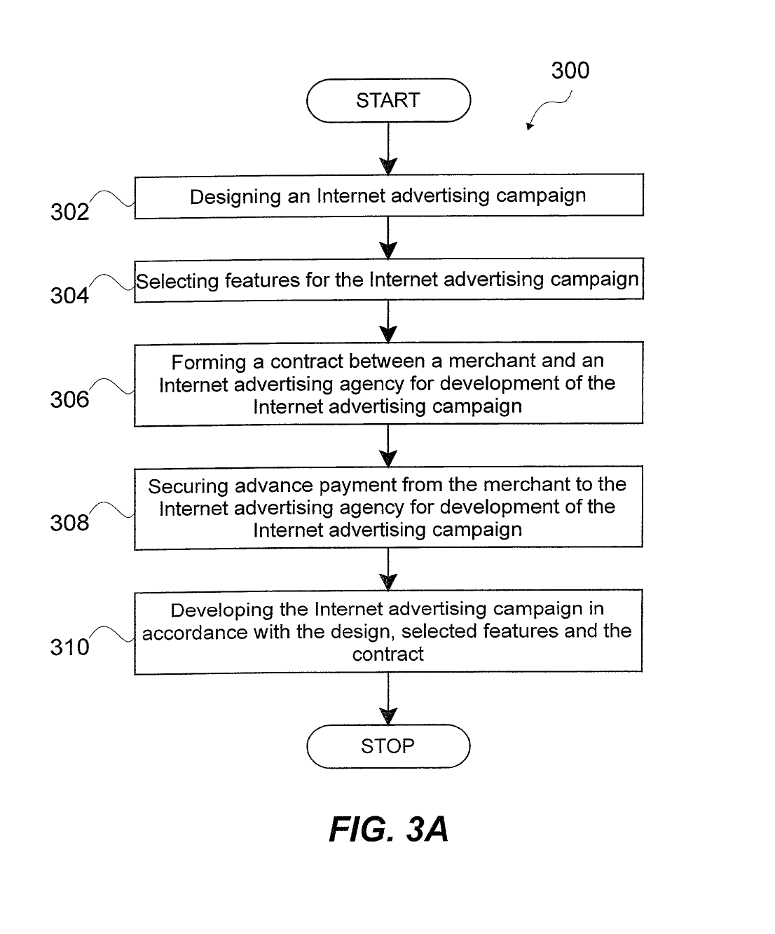

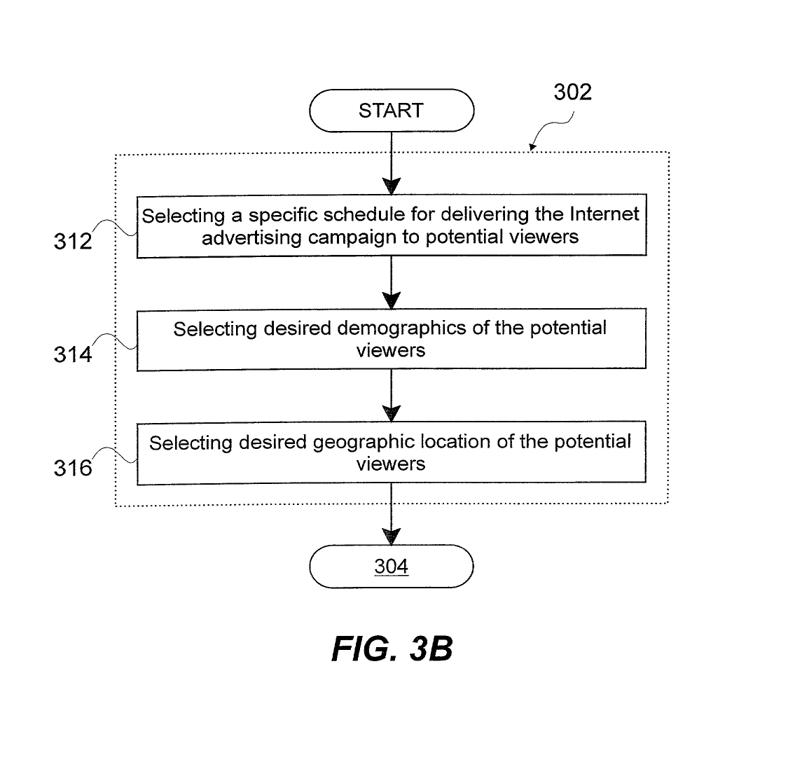

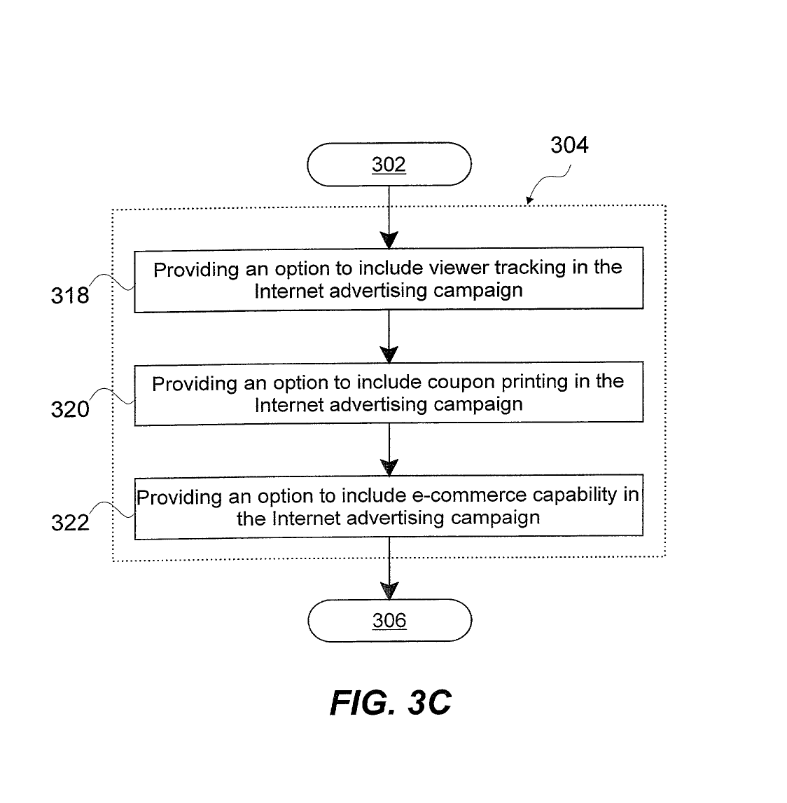

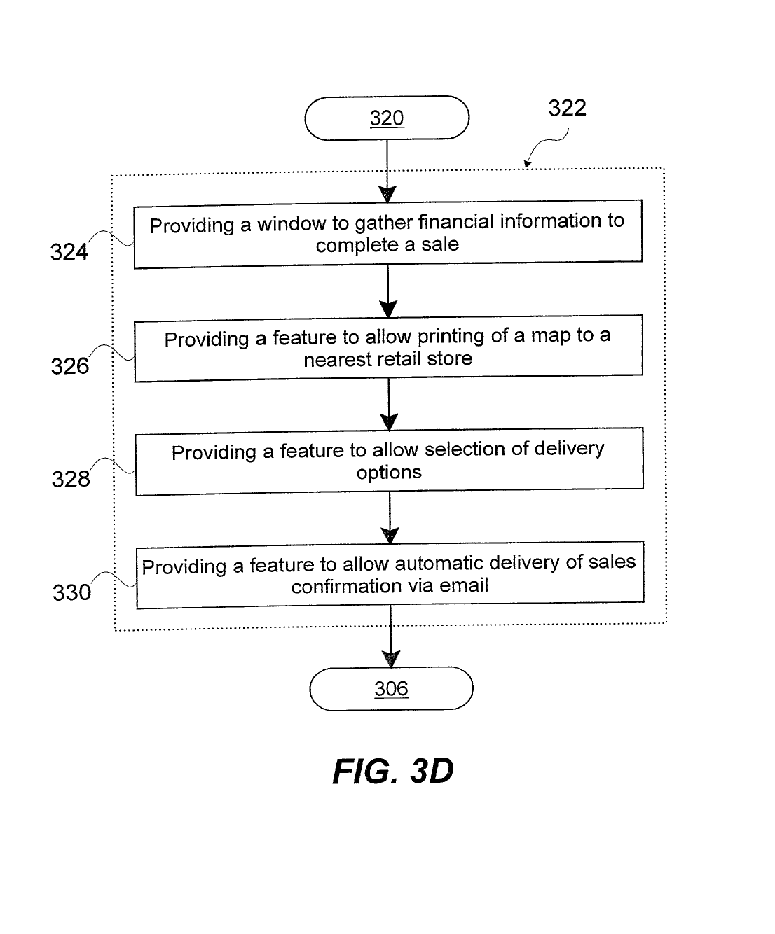

FIG. 3A is a flow chart of a method 300 of configuring an Internet advertising campaign for advertising goods or services over the Internet in accordance with the present invention. FIGS. 3B-3D are flow charts providing added detail to the method 300 of FIG. 3A. Method 300 includes designing 302 an Internet advertising campaign, selecting 304 features for the Internet advertising campaign, forming 306 a legal relationship (or contract) between a merchant and an Internet advertising agency for development of the Internet advertising campaign, securing 308 advance payment from the merchant to the Internet advertising agency for development of the Internet advertising campaign, and developing 310 the Internet advertising campaign in accordance with the design, the selected features and the contract.

Referring to FIG. 3B, designing 302 an Internet advertising campaign may include selecting 312 a specific schedule for delivering the Internet advertising campaign to potential viewers of advertisements from the advertising campaign, selecting 314 desired demographics of the potential viewers of advertisements from the advertising campaign, and selecting 316 desired geographic location of the potential viewers. Selecting 312 a specific schedule may include, for example and not by way of limitation, particular days of the week and/or specific ranges of time during the day, and duration of Internet advertising campaign. Selecting 314 desired demographics may include, for example and not by way of limitation, sex, age, average income, education level, hobbies and interests (auto, health, fitness, sports, business, apparel, etc.) of the potential viewer. Selecting 316 desired geographic location may include, for example and not by way of limitation, selecting from among the address, zip code, city, county, state, country and ISP of the potential viewer.

Referring to FIG. 3C, selecting 304 features for the Internet advertising campaign may include providing 318 an option to include viewer tracking in the Internet advertising campaign, providing 320 an option to include coupon printing in the Internet advertising campaign, and providing 322 an option to include e-commerce capability in the Internet advertising campaign. Providing 318 an option to include viewer tracking may include, for example and not by way of limitation, tracking the potential viewer with a cookie. Providing 320 an option to include coupon printing may include, for example and not by way of limitation, an option to allow the potential viewer to print a coupon with a bar code on it, and/or with directions to a nearest retail outlet. Additionally, the coupon may be customized to a select retail store or group of stores as opposed to any and all retail stores. Such customization allows for localized sales or select inventory reduction.

Referring to FIG. 3D, providing 322 an option to include e-commerce capability in the Internet advertising campaign may include providing 324 a window to gather financial information to complete a sale, providing 326 a feature to allow printing of a map to a nearest retail store, providing 328 a feature to allow selection of delivery options, and providing 330 a feature to allow automatic delivery of sales confirmation via email. Financial information necessary to complete a sale may include, for example and not by way of limitation, credit card number, credit card type, name on the credit card, expiration, billing address, shipping address, email address, telephone number, and the like.

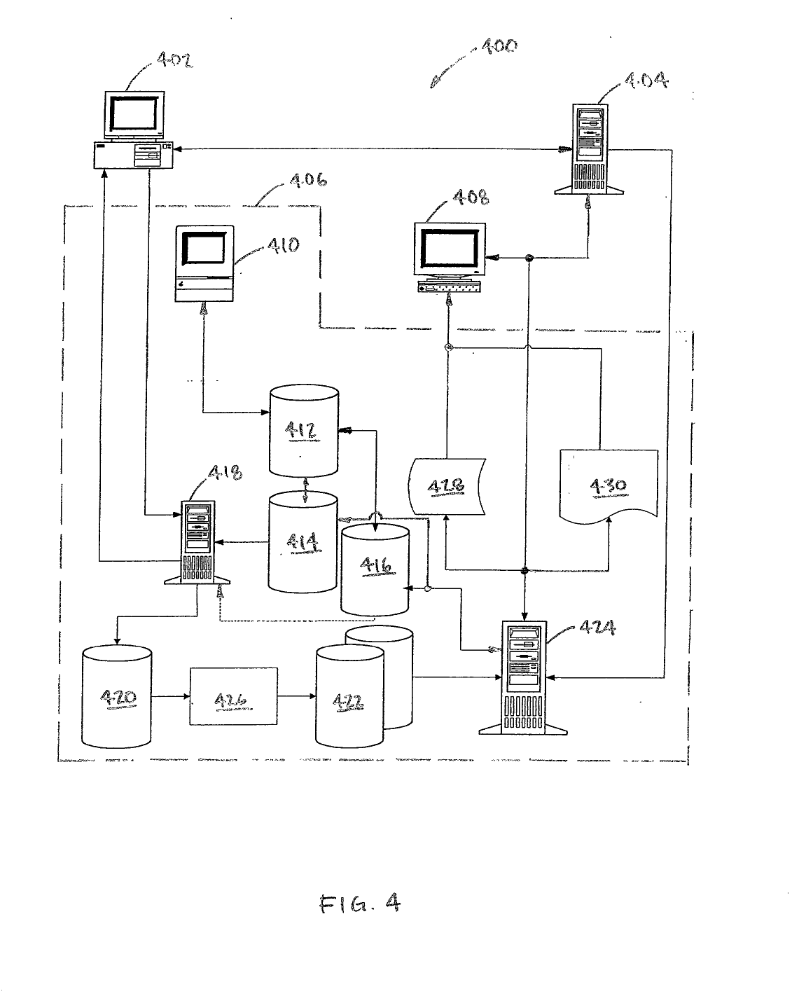

FIG. 4 is a block diagram of a system 400 for developing, delivering, and monitoring an Internet advertising campaign in accordance with the present invention. System 400 includes a viewer computer 402 configured for connection to a host server computer 404, an advertising agency computer system 406 configured for connection to the viewer computer 402 and the host server computer, and a merchant computer 408 configured for connection to the advertising agency computer system 406 and the host server computer 404. The preferred connections between computers 402, 404, 406 and 408 are accomplished through the Internet using any hardware, software and protocols known to one of ordinary skill in the art. Alternatively, connections between computers 402, 404, 406 and 408 may be effected through a wide area network (WAN) as known to one of ordinary skill in the art.

Advertising agency computer system 406 may further include a development computer 410, development mass storage 412, advertising mass storage source A 414, advertising mass storage source B 416, advertising server computer 418, statistics mass storage 420, warehouse mass storage 422, warehouse server computer 424. Development computer 410 is configured for connection to development mass storage 412. Development mass storage 412 is configured for connection to advertising mass storage source A 414 and advertising mass storage source B 416. Advertising mass storage source A 414 and advertising mass storage source B 416 are configured for connection to advertising server computer 418. Advertising server computer 418 is configured for connection to statistics mass storage 420. Statistics mass storage 420 is configured for connection to warehouse mass storage 422. Warehouse mass storage 422 is configured for connection to warehouse server computer 424. Warehouse server computer 424 is configured for connection to the merchant computer 408, the host server computer 404 and advertising mass storage source A 414 and advertising mass storage source B 416.

While mass storage devices 412, 414, 416, 420 and 422 are all illustrated as mass storage devices, e.g., fixed disk drive, removable disk drive, magneto-optic drive, digital versatile disk read only memory (DVD-ROM), compact disc ROM (CD-ROM), and the like, one of ordinary skill in the art will recognize that a computer including memory of virtually any kind could also be used or substituted in place of each of the mass storage devices 412, 414, 416, 420 and 422. Additionally, it is within the scope of the invention to combine certain elements described in this particular system 400 and yet remain within the scope of the invention. For example, and not by way of limitation, statistics mass storage 420 and warehouse mass storage 422 may be combined into a single computer with mass storage for performing the same functions as the individual components 420 and 422. Alternatively, statistics mass storage 420 may be a component, such as a hard disk drive, of advertising server computer 418 and warehouse mass storage 422 may be a component, such as a hard disk drive, of warehouse server computer 424. Similarly, development mass storage 412 may be a component of development computer 410, and advertising mass storage sources A 414 and B 416 may be disk drives on advertising server computer 418.

Statistics mass storage 420 may be used to generate statistics based on raw information gathered by the advertising server computer 418. Such statistics may, for example, and not by way of limitation, include demographics, geographical location and like information about the viewers who have been tracked by the advertising computer 418 during a given period of time. Statistics mass storage 420 may also generate an extract 426 or distillation 426 of the statistics for further manipulation by warehouse mass storage 422 and use by warehouse server computer 424.

Warehouse server computer 424 may provide summary reports 428 based on the statistical extract 426 to the merchant computer 408. Warehouse server computer 424 may also provide advertising campaign reports 430 based on a particular Internet advertisement or a group of Internet advertisements to a merchant at a merchant computer 408. The summary reports 428 and advertising campaign reports 430 may be used by a merchant to evaluate the effectiveness of a given Internet advertising campaign or to develop a new Internet advertising campaign. The summary reports 428 and advertising campaign reports 430 may be accessed realtime, anytime and over the Internet if so configured.

FIG. 5 is a picture of an exemplary rich-media advertisement in accordance with the method of FIGS. 1A and 1B of the present invention. The exemplary advertisement shown in FIG. 5 would be displayed during execution 114 of a first portion of the advertising computer program. FIG. 6 is a picture of an exemplary promotional window displaying a trailer in accordance with the method of FIGS. 1A and 1B of the present invention. The exemplary trailer shown in FIG. 6 would be displayed in a promotional window on a viewer's computer during execution 118 of a second portion of the advertising computer program. FIG. 7 is a picture of an exemplary sales portal window in accordance with the method of FIGS. 1A and 1B of the present invention. The exemplary sales portal window shown in FIG. 7 is opened 122 after the viewer's attention is confirmed (yes) 119.

Although this invention has been described with reference to particular embodiments, the invention is not limited to these described embodiments. Rather, the invention is limited only by the appended claims, which include within their scope all equivalent devices or methods that operate according to the principles of the invention as described herein.

What is claimed is:

1. A system for delivering rich-media Internet advertisement, wherein said advertisement may optionally include audio, video and animation capabilities, said system comprising:
a viewer computer configured for Internet connection;
a server computer configured for Internet connection; and
a computer program configured for being electronically transmitted through the Internet from said server computer to said viewer computer when a viewer addresses said server computer, wherein said computer program is configured to:
pre-load in background on said viewer computer when received thereby;
execute said rich-media Internet advertisement in a window on said viewer computer for a duration between about 2 seconds to about 30 seconds after said pre-loading; and
leave a promotional window to gather a mouse-over or a click-through from said viewer.

2. The system of claim 1, wherein said viewer computer is configured for full stereo audio delivery to said viewer.

3. The system of claim 1, wherein said promotional window closes automatically in a period of between about 2 seconds and about 60 seconds in the absence of a mouse-over or a click-through from said viewer.

4. The system of claim 1, wherein said promotional window may be activated responsive to a viewer moving a cursor over said promotional window.

5. The system of claim 1, wherein said computer program is pre-loaded on said server computer before transmission to said viewer computer.

6. The system of claim 1, wherein said computer program is further configured to generate a sales portal window if said click-through is gathered, wherein said sales portal window includes:
an option to view a plurality of promotional offers from within said sales portal window;
an option to purchase online at least one item or service described in at least one of said promotional offers; and
an option to print said promotional offers.

7. The system of claim 6, wherein said sales portal window further includes:
mapping tools to guide the viewer to a nearest retail store for promotional offers linked to retail stores; and
an option to select from a plurality of delivery choices.

8. The system of claim 6, wherein said sales portal window further includes a hyperlink to an advertiser website associated with each of said plurality of promotional offers.

9. The system of claim 6, wherein said sales portal window further includes a capability to perform a keyword search of said plurality of promotional offers.

10. A method for delivering rich-media Internet advertising, wherein said advertisement may optionally include stereo audio, video and animation capabilities, said method comprising:
providing a host computer configured for hosting a web site including Internet connection;
providing a server computer configured for Internet connection and including an advertising computer program stored in memory in said server computer;
providing a viewer computer configured for Internet connection and including an Internet browser;
profiling a viewer addressing said web site on said host computer through said Internet;
transmitting said advertising computer program from said server computer to said viewer computer;
pre-loading said transmitted advertising computer program in background on said viewer computer;
executing a first portion of said advertising computer program in an advertising window on said viewer computer for between about 2 seconds to about 30 seconds;
automatically closing said advertising window;
executing a second portion of said advertising computer program in a promotional window to confirm said viewer's attention; and
automatically closing said promotional window if said viewer's attention remains unconfirmed for between about 2 seconds to about 60 seconds after said promotional window opens.

11. The method of claim 10, wherein said profiling a viewer includes:
said host computer returning a merchant number and wheel number to said viewer computer;
said viewer computer sending merchant specific information to said server computer; and
said server computer transparently communicating with said viewer computer.

12. The method of claim 11, wherein said merchant specific information includes a merchant number for identifying a unique merchant and a wheel number for identifying a unique advertiser.

13. The method of claim 11, wherein said transmitting said advertising computer program from said server computer to said viewer computer comprises sending a selected advertising computer program based on said merchant specific information.

14. The method of claim 10, wherein said profiling said viewer includes gathering time information, demographics, geographic location, hardware information and tracking information.

15. The method of claim 10, further comprising tracking said viewer with a cookie.

16. The method of claim 10, wherein said viewer's attention may be confirmed by either a mouse-over event or by a click-through event.

17. The method of claim 10, further comprising:
opening a sales portal window if said viewer's attention is confirmed;
providing an option to buy at least one promotional item online;
providing an option to print promotional offers;
providing a map to locate a nearest retail store to said viewer's location; and
providing an option to hyperlink to an advertiser's web site.

18. A method for configuring an Internet advertising campaign for advertising goods or services over the Internet, comprising:
designing said Internet advertising campaign;
selecting features for said Internet advertising campaign;
forming a contract between said merchant and said Internet advertising agency for development of said Internet advertising campaign;
securing advance payment from said merchant to said Internet advertising agency for said development of said Internet advertising campaign; and
developing said Internet advertising campaign in accordance with said Internet advertising design, said selected features for said Internet advertising campaign and said legal relationship.

19. The method of claim 18, wherein said designing, said selecting, said instantiating and said securing are all performed realtime over the Internet.

20. The method of claim 18, wherein said designing said Internet advertising campaign comprises:
selecting a specific schedule for delivering said Internet advertising campaign to potential viewers;
selecting desired demographics of said potential viewers; and
selecting desired geographic location of said potential viewers.

21. The method of claim 18, wherein said selecting features for said Internet advertising campaign includes:
providing an option to include viewer tracking in said Internet advertising campaign;
providing an option to include coupon printing in said Internet advertising campaign; and
providing an option to include e-commerce capability in said Internet advertising campaign.

22. The method of claim 21, wherein said e-commerce capability includes:
providing a window to gather financial information to complete a sale;
providing a feature to allow printing of a map indicating directions to a nearest retail store;
providing a feature to allow selection of delivery options; and
providing a feature to allow automatic delivery of sales confirmation via email.

23. A method for creating and managing an Internet advertising campaign realtime, comprising:
providing a password protected merchant user interface to allow a merchant to supply or revise merchant information;
designing said Internet advertising campaign;
automatically generating a contract to document said designed Internet advertising campaign; and
securing payment for said designed Internet advertising campaign.

24. The method of claim 23, wherein said merchant information comprises contact person, billing information and password.

25. The method of claim 23, wherein said designing said Internet advertising campaign comprises:
selecting a range of time and week days for running an Internet advertisement;
selecting target demographics for said Internet advertisement; and
selecting desired geographical target for said Internet advertisement.

26. The method of claim 23, wherein said securing payment for said designed Internet advertising campaign comprises verifying merchant's funds and obtaining full payment before execution of said Internet advertising campaign.
